(19) United States
(12) Patent Application Publication
(10) Pub. No.: US 2010/0002025 A1
(43) Pub. Date: Jan. 7, 2010

(54) 2D-DIMMING OF ILLUMINATING MEMBER FOR DISPLAY DEVICE

(75) Inventors: Jean Paul Jacobs, Eindhoven (NL); Roel Van Woudenberg, Eindhoven (NL); Erno Hermanus Antonius Langendijk, Eindhoven (NL); Martijn Henri Richard Lankhorst, Eindhoven (NL); Gerard Harbers, Sunnyvale, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/522,962

(22) PCT Filed: Feb. 11, 2008
(86) PCT No.: PCT/IB2008/050476

§ 371 Date: Jul. 13, 2009

Related U.S. Application Data
(60) Provisional application No. 60/890,216, filed on Feb. 16, 2007.

(51) Int. Cl. G09G 3/36; G02F 1/13357; G09G 5/10

(52) U.S. Cl. 345/690; 362/97.3; 345/102

(57) ABSTRACT

An illuminating member (4) that, independent of any image content, comprises a central region (5) and an enclosing region (6), wherein said enclosing region (6) is adapted to emit light of lower quality than the light emitted by the central region (5). The illuminating member is adapted to illuminate a display panel (2) of a display device. By having the enclosing region emit light of lower brightness (dimming) a significant power reduction can be achieved for a wide range of typical images while largely maintaining the perceived image quality. Further, by using light emitting elements of lower quality for the enclosing region, manufacturing costs may be reduced while largely maintaining the perceived image quality.

### TECHNICAL FIELD

The present invention relates to an illuminating member for illuminating a display panel to create an image.

### BACKGROUND OF THE INVENTION

Dimming of display panel illumination is today widely applied in electronic devices such as MP3 players, mobile phones, portable computers, and TV-applications. For displays requiring high performance, increased dynamic contrast and reduced power consumption can be achieved by segmenting the illumination of the display panel into a large number of segments and, for each segment, controlling the dimming based on the corresponding image content. This is however associated with a considerable cost penalty, as each segment needs its own driver circuit and moreover extra LED power has to be installed to be able to boost the LEDs to compensate for the lost brightness contribution of neighboring dimmed segments. This kind of system is thus often too expensive for use in, for example, a consumer TV.

A more cost effective way to reduce power consumption of backlight displays is disclosed in EP 1 653 435. The technology described is intended for backlight displays in electronic equipment such as CD, MP3 players and mobile phones, and divides the area of the backlight unit into segments, where the intensity of light backlighting each such segment can be controlled separately. Thus, illumination of various segments of the display can be adjusted for instance depending on the mode or application of the electronic equipment, thereby reducing the energy consumption of the display unit as a whole.

However, the methods in EP 1 653 435 tend to dim a part of the display not currently active. For dimming a part of the display that is active, the dimming is typically made dependent on the image content and the illumination is segmented into a large number of segments to achieve satisfactory image quality, thereby resulting in a significant additional cost. It would thus be of value to have a cost-effective scheme for dimming.

### SUMMARY OF THE INVENTION

In view of the above, an objective of the invention is to solve or at least reduce the problems discussed above.

According to a first aspect of the invention, there is disclosed an illuminating member that, independent of any image content, comprises a central region and an enclosing region enclosing the central region, said enclosing region being adapted to emit light of lower quality than the light emitted by the central region.

The expression “light of lower quality” is intended to indicate light that when used to illuminate the display panel may contribute less to a high perceived image quality of the displayed image, such as, for example, light having lower brightness or a lower color quality.

There is always a trade-off between displaying the image in high quality, and cost-efficiency. Further, the image quality perceived by a viewer is not absolute, but rather perceptive. As the main subject of an image is very often positioned in the center of the image, a viewer, for example watching a TV-program, typically is more sensitive to reduced image quality of the central region of the image.

Thus, the present invention is based on the realization that an effective way to reduce costs, while largely maintaining perceived image quality for a wide range of typical images, is to segment the display into a central region and an enclosing region, with the enclosing region having lower image quality.

The fact that the enclosing region is adapted to emit light of a lower quality independent of the image content is only intended to indicate that the quality of light emitted by the enclosing region is on average lower than the overall light quality of the central region, regardless of image content. However, the details of the “dimming” is not necessarily independent of image content.

On the contrary, the ratios of the light quality between central and enclosing regions may well be dependent on the image content, and may indeed be adapted during operation (as will be explained further below). Further, the quality of light within the central and/or enclosing region may also be dependent on the image content.

By having the enclosing region emit light of lower brightness (dimming), a significant power reduction can be achieved for a wide range of typical images while largely maintaining the perceived image quality.

Further, by using light emitting elements of lower quality for the enclosing region, manufacturing costs may be reduced while largely maintaining the perceived image quality.

Light emitting elements such as LEDs typically have large variation in light characteristics. One example is the variation of optical flux output at the same drive conditions. Another example is the wavelength variation of a pumping blue LED present in (remote) phosphor systems, that causes the total white flux, as well as the exact color coordinates of the white light, to vary.

For this reason, manufacturers of LED systems typically utilize an advanced production binning process, where LEDs are categorized, to maintain light quality (e.g. color and flux) consistency. By utilizing light emitting elements from various categories in various regions of the illuminating member, the full distribution of LEDs can be used while largely maintaining the perceived image quality. Thus, LED rejection is limited, and manufacturing costs are reduced.

Segmenting the illuminating member into a small number of regions has the additional advantage that a cost-efficient illuminating member, and thus display, can be achieved as the number of additional illuminating drive circuits needed are limited and additional cost increase is avoided. (This is understood as a typical display for TV application has more than 50 light emitting elements and two to four illuminating drive circuits also for a display not utilizing background dimming.)

A small number of regions is particularly beneficial for certain types of illuminating members such as RGB-backlights with discrete R-, G- and B-packages, where the differently colored LEDs are positioned apart. To better understand this, the term illumination transfer function is introduced, describing the illumination pattern of a single segment, or that of the total backlight, depending on context. In a typical backlight, the optics behave such that light of many segments or light emitting elements is mixed in the backlight casing. This smoothes small color and luminance differences, and results in a smooth luminance drop-off also when there are sharp boundaries in the driven sources themselves. Such a smooth luminance drop-off is referred to as a smooth or wide illumination transfer function. A smooth illumination transfer function is typically required for discrete R-, G- and B-packages, where the colors are separated in space in the backlight unit, and thus need to be well-mixed before they illuminate the display panel from the back, as the illumination needs to be “white”. Whereas a smooth illumination transfer function tends to be in conflict with high resolution 2D-dimming schemes, it is highly compatible with a small number of regions. A smooth transfer function may actually be beneficial as it prevents the visibility of boundaries between regions.

The enclosing region may be adapted to emit light with a lower brightness than the light emitted by the central region. As a viewer typically is more sensitive to reduction in image quality for the central region than for the enclosing region, it would be preferable to dim the brightness of the enclosing region more than the brightness of the central region. This allows a significant power reduction, while largely maintaining perceived image quality for a wide range of typical images.

The area of the central region may have essentially the same size as the area of the enclosing region. This will provide a reasonable trade-off between cost-efficiency and perceived image quality, as under these circumstances the main subject of a typical image is normally captured within the central region.

Further, when both regions are equally sized in terms of number of light emitting elements, the same drive voltage (with all light emitting elements in series) can be applied to both regions. Thus, the use of identical illuminating drive circuits for both regions is facilitated. It would also be very reasonable to have three illuminating drive circuits, one for the central region and two for the enclosing region, with the size of the enclosing region being twice the size of the central region.

The enclosing region may be adapted to emit light with a brightness which is less than 70% of the brightness of the light emitted by the central region and preferably approximately 50%. This will provide a reasonable trade-off between power reduction and perceived image quality.

At least one of the central region and the enclosing region may be further segmented into a lower sub-region and an upper sub-region, each emitting light with different quality. This allows cost-efficiency, such as power reduction and/or reduced manufacturing costs, while largely maintaining perceived image quality in particular when the image content shows different brightness in the upper and lower half of the image as, for example, is generally the case for natural scenes with a bright sky and a darker foreground.

The illuminating member may be provided with a controller that adjusts the quality of the light emitted by the central region and/or the enclosing region. Having a controller adjust the dimming has the advantage that the dim ratio, for example, between central region and enclosing region can be adaptive depending on the application. As an example, the segmented dimming can be inactivated when the display is used as a PC monitor to get a (close-to) flat brightness distribution. Alternatively, the brightness difference between the different segments can be reduced in that case.

A controller may adjust the quality of the light emitted by the central region and/or the enclosing region based on received image data. This may include the absolute value as well as the ratio between the central region and the enclosing region. As the main subject of an image is very often positioned in the center of the image, this method will generally be very effective when the illuminating member is segmented into a central region and an enclosing region. It may help increase the contrast within an image, and improve the perceived image quality. It may also provide further power reduction.

The central region and the enclosing region each may comprise a plurality of light emitting elements. Thus, the surface density of light emitting elements may vary between the regions.

The surface density of light emitting elements may be lower in the enclosing region than in the central region. As, in this case, there are fewer light emitting elements per unit area in the enclosing region than in the central region, dimming can be achieved even though each individual light emitting element is driven with the same light characteristics. This may reduce the number of light emitting elements needed and allow simplified drive electronics, thereby further reducing costs.

The light emitting elements may be categorized based on light quality, and light emitting elements belonging to a first category may be positioned in a first region of the illuminating member and light emitting elements belonging to a second category may be positioned in a second region of the illuminating member.

By utilizing light emitting elements from various categories in various regions of the illuminating member, the full distribution of LEDs can be used while largely maintaining the perceived image quality. Thus, LED rejection is limited, and manufacturing costs are reduced. The color variations between various categories may even be exploited to enhance the perceived image quality. For example, deeper blue LEDs can be placed in the upper sub-region of the enclosing region (for the higher color temperature of the sky), whereas the longer wavelength blue can be placed in the lower sub-region of the enclosing region.

An illuminating member according to an embodiment of the invention is advantageously fitted together with a display panel to form a display device. The illuminating member can be any device for illumination of the display panel, such as a frontlight or a backlight.

The display may further be provided with a light sensor connected to the controller that adjusts the quality of the light emitted by the central region and/or the enclosing region based on the ambient light level. This allows further power reduction while largely maintaining perceived image quality, especially in dark ambience.

According to another aspect of the invention, a method of driving an illuminating member arranged to illuminate a display panel to create an image is provided. The method comprises controlling a central region to emit light of a first quality, and controlling an enclosing region, enclosing the central region, to emit light of a quality lower than the first quality, said central region and said enclosing region being defined independently of any image content.

This method allows a significant power reduction for a wide range of typical images while largely maintaining the perceived image quality.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a schematic exploded view of a display device according to an embodiment of the invention.

FIG. 2 illustrates a schematic block diagram of the display device in FIG. 1.

FIG. 3 illustrates an example of segmentation of the illuminating member in FIG. 2 into regions and sub-regions.

FIG. 4 illustrates a schematic view of a segmentation of a backlight used in a simulation.

### DETAILED DESCRIPTION OF PREFERRED EMBODIMENTS

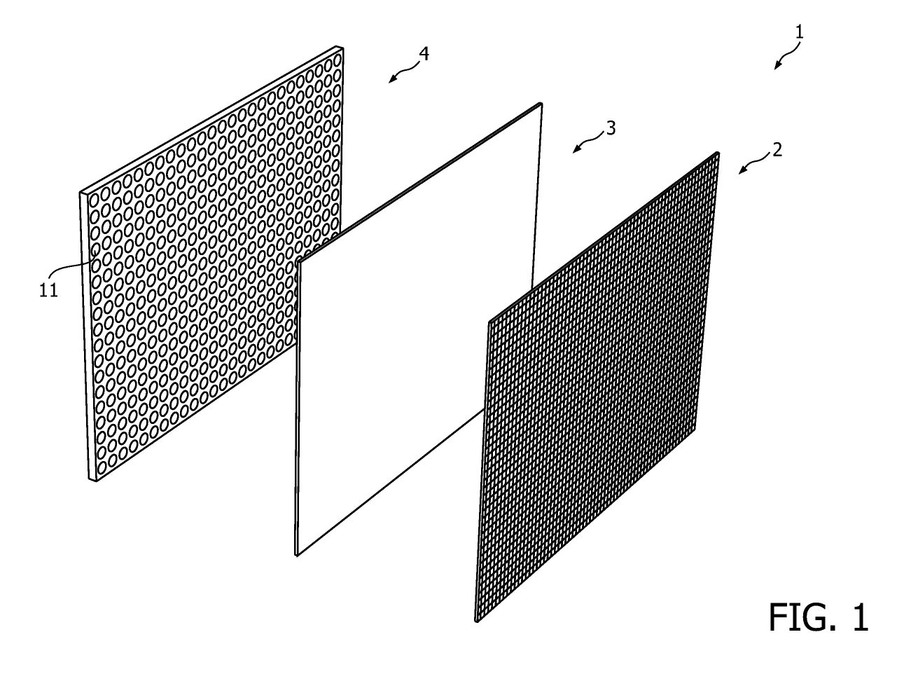

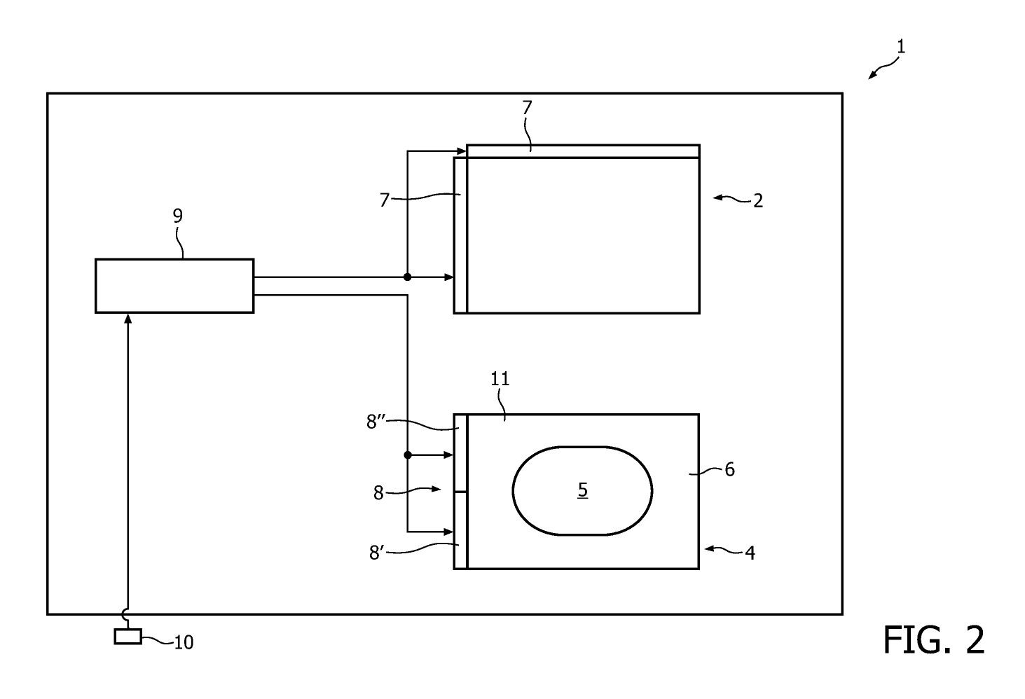

FIGS. 1-2 are schematic views of the display 1 according to one embodiment of the present invention. The display 1 comprises an illuminating member 4 and a display panel 2. In the present example the illuminating member 4 is arranged behind the display panel 2, and is thus referred to as a backlight. The backlight 4 may have a plurality of light emitting elements 11. The light emitting elements 11 can be red (R), green (G) and blue (B) light emitting diodes (LEDs), whereas alternative embodiments may utilize a phosphor-converted whitish light, either from phosphor conversion at the LED (on the die or on the lens) or from phosphor conversion at a plate positioned remotely. The backlight 4 may be connected to a controller 9 through illuminating drive circuits 8.

As illustrated in FIG. 1, the display 1 may also comprise an optical system 3 positioned between the backlight 4 and the display panel 2. The optical system 3 comprises e.g. a diffuser plate and/or brightness enhancing foils and/or other optical plates or sheets, which serve(s) to distribute the light evenly and efficiently.

As regards the display panel 2 illustrated in FIG. 1, it is formed by a plurality of pixels. The display panel 2 can comprise a vessel formed by, for example, transparent substrates disposed in opposition to each other with a liquid crystal interposed therebetween. As illustrated in FIG. 2, each pixel may be connected to the controller 9 through display panel drive circuits 7. In the illustrated example, the display panel and the illuminating member are connected to the same controller 9. Of course, it is also possible to have independent controllers for the panel and the illuminating member.

Referring to FIG. 2, the backlight 4 is segmented into a central region 5 and an enclosing region 6, each having its own illuminating drive circuit 8′,8″.

The central region 5 can have a surface area having essentially the same size as the enclosing region 6.

The shape of the central region 5 can be selected based on various factors. An oval shape, as in FIG. 2, tends to better preserve the perceived image quality, such as color and brightness uniformity of the image, also for steep transfer functions. However, a rectangular shape may be advantageous from a manufacturing perspective.

In this embodiment the number of light emitting elements 11 is preferably the same in the central region 5 and in the enclosing region 6.

In operation, light may be emitted by the light emitting elements 11 of the backlight 4, whereas light quality, such as the brightness or color point, may be adjusted by the controller 9, through the illuminating drive circuits 8′,8″, in accordance with a desired dimming scheme. In this way the “warm”, “cold” and “neutral” settings found in TV-applications (typically 9000 K or even up to 11000 K CCT) can be implemented, as well as the color temperature settings on PC screens (typically “D65”, i.e. the standard illuminant D65 which is close to the 6500K black body point)

Light from the light emitting elements may be mixed in the backlight casing of the backlight 4, before reaching the optical system 3 that serves to distribute the light evenly and efficiently. As the light is transmitted through the liquid crystal so as to reach the eyes of an observer, an image appears on the display panel 2. This image can be adjusted to reflect the received image data (received by the controller 9 from the outside of the display 1) as the controller 9, through the display panel drive circuits 7, controls the optical transmission of the liquid crystals of the individual pixels of the display panel 2.

Whereas the pixels of the display panel 2 typically are adjusted based on the image content, the light characteristics emitted by the backlight 4 may depend on a dimming scheme, which can be independent of the image content. For example, according to one dimming scheme for the embodiment illustrated in FIG. 2, the controller 9 sets the brightness level for the central region 5 to 100%, while the brightness level for the enclosing region 6 is set to 50%, independent of the image content. The result is a (50%*100%+50%*50%)=75% power usage, that is a power reduction of 25%.

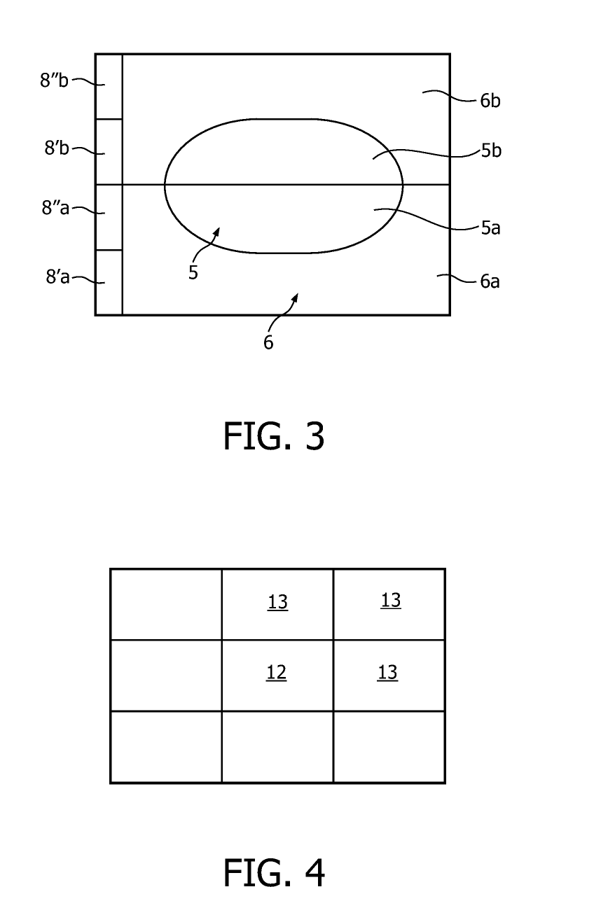

As illustrated in FIG. 3, the central region 5 and/or the enclosing region 6 can be further segmented into sub-regions, each emitting light with different quality. Here, both the central region 5 and the enclosing region 6 have been further segmented into a lower sub-region 5a,6a and an upper sub-region 5b,6b, each sub region 5a,5b,6a,6b having a separate illuminating drive circuit 8a′,8b′,8a″,8b″.

The display may be provided with a light sensor 10 connected to the controller 9, as illustrated in FIG. 2. The light sensor 10 provides the controller 9 with information about the ambient light level. Thus, the controller 9 may utilize a dimming scheme dependent on the ambient light level. Typically, in dark ambience the brightness of the central region is reduced from 100% to 50% brightness, while the ratio between the brightness of central region 5 and enclosing region 6 remains fixed at 50%. This results in a power usage of 50%*(50%*100%+50%*50%)=37.5%, that is a power reduction of 62.5% compared to a non-dimming display.

The brightness of the central region 5 and/or the enclosing region 6 may also be set by a 0D-dimming level determined from image content, herewith incorporated by reference to N. Raman and G. Hekstra, Dynamic Contrast Enhancement of Liquid Crystal Displays with Backlight Modulation, Digest of technical paper of ICCE 2005.

The idea is to dim the backlight by an overall factor, while opening the pixels in the display panel with the inverse of the dimming factor. This way the front-of-screen brightness is maintained. The dim factor can be obtained from a Raman-Hekstra algorithm applied to the whole panel, as that guarantees that no pixels need to be driven beyond their maximum transmission.

As 0D-dimming reaches a power consumption of about 25% when applied for the panel as a whole, this results in a power level of 75%*(50%*100%+50%*50%)=56%, i.e. a reduction of the power consumption by 44%, assuming the ratio between the brightness of the central region and the enclosing region still being fixed at typically 50%. Thus, there is an additional 19% saving compared to 0D-dimming without any significant additional cost.

Note that 0D-dimming or 0D-boosting can also be used without this luminance-preservation: for example, the backlight may be boosted without reducing the pixel transmission to make a short temporal flash (at the cost of image contrast). Also, to have some additional power saving, the reduced backlight brightness may be only partially compensated when dimming. Thus, by accepting e.g. a 10-20% brightness loss, it is possible to dim a bit deeper than strictly allowed.

The dimming of various backlight regions can be dependent on the corresponding image content for the respective regions. As an example, the controller 9 in FIG. 2 may receive and process image data from outside the display 1. Based on the information contained herein about the image content corresponding to the central region 5 and the enclosing region 6, the controller 9 adjusts the illumination of the respective region. This may include the absolute value of each region as well as the ratio between the central region and the enclosing region.

In a typical application, the central region 5 may be dimmed to 75% brightness and the enclosing region 6 may be fully dimmed. Thus, the power reduces to 37.5% and a power reduction of 62.5% is achieved.

Dimming can also be achieved through the physical arrangement of the illuminating member 4. By arranging the light emitting elements 11 in the enclosing region 6 with a lower surface density (i.e. fewer light emitting elements per unit area) than the light emitting elements 11 in the central region 5, the illumination from the enclosing region 6 can achieve a lower brightness than the illumination from the central region 5. Thus, the enclosing region is dimmed and power consumption is reduced.

The categorization of light emitting elements resulting from production binning can, for example, be utilized as follows. Referring to FIG. 3, the light emitting elements 11 with the lowest flux are typically placed in the enclosing region 6, in particular in the lower sub-region 6a of the enclosing region. The light emitting elements 11 with the highest flux are typically placed in the central region 5. Optionally, light emitting elements with average efficiency could be placed in the upper sub-region 6b of the enclosing region.

For LED backlights being (remote) phosphor systems, the categorization can be utilized as follows. Referring to FIG. 3, deeper blue LEDs can be placed in the upper sub-region 6b of the enclosing region (for the higher color temperature of the sky), whereas the longer wavelength blue can be placed in the lower sub-region 6a of the enclosing region.

In a simulation the backlight is divided into nine equally sized rectangular segments 12,13, as illustrated in FIG. 4. It is assumed that the target luminance for the backlight can be estimated as the square root of the maximum luminance for the image. Knowing the target luminance of the backlight, the drive values for the illuminating drive circuits are also known. Thus, for all pixels in each segment 12,13 the square root of the maximum of the luminance is taken. For the surrounding segments 13, the values are averaged so they all get the same drive value. The center segment 12 could also be filtered with

$$[ \begin{matrix}1 & 1 & 1 \\ 1 & 2 & 1 \\ 1 & 1 & 1\end{matrix} ] / 10$$

to peak the center LED.
In the simulation, the final result for the drive values of all segments 12,13 is:

$${D}_{Seg} = [ \begin{matrix}0.6050 & 0.6050 & 0.6050 \\ 0.6050 & 0.9111 & 0.6050 \\ 0.6050 & 0.6050 & 0.6050\end{matrix} ]$$

In the case of a system with a central region and an enclosing region (where the centre segment 12 forms the central region, and the eight remaining surrounding segments 13 form the enclosing region), the drive values are:
Central region=0.9111
Enclosing region=0.6050
Note that in a practical application the surface of the central region preferably would be equal to that of the enclosing region (in the simulation the ratio central region:enclosing region=1:8).

A first simulation of the contrast improvement has been performed as follows. The simulation uses a rectangular centre segment 12 and a very steep transfer function to clearly show the effects. The centre segment 12 is dimmed only a little bit, while the surrounding segments 13 are dimmed significantly. As a result, contrast is improved and power consumption is reduced. The surrounding dark area becomes darker as any LCD leakage is reduced, while the center luminance is essentially maintained.

When the transition is made smoothly, as in a true backlight with wider transfer functions, the segmentation will not be visible while the contrast improvement and power reduction are largely maintained. There will be a small penalty to the brightness of the centre segment 12 in the situation where this needs 100% front-of-screen brightness and the surrounding segments 13 are fully dimmed, due to the lacking contribution of light from the surrounding segments 13 to the centre segment 12. This is however not annoying for such high-dynamic-range images, and can be fully recovered as soon as the required central front-of-screen brightness is a bit lower: the centre segment 12 is then driven with full brightness to compensate this loss of the surrounding segments 13.

The dimming strategies and embodiments described hereinbefore have covered approaches where a controller adjusts the dimming as well as approaches where the dimming relates to the physical arrangement of the illuminating member. As will be understood by a person skilled in the art, these approaches can be combined. Further, it is also understood that techniques and dimming strategies as described herein for the central region and/or the enclosing region may just as well be applied for possible sub-regions.

The invention has mainly been described with reference to a few embodiments. However, as is readily appreciated by a person skilled in the art, other embodiments than the ones disclosed above are equally possible within the scope of the invention, as defined by the appended patent claims. For example, the illuminating member can be a frontlight, arranged to emit light away from a viewer to pass through a display unit and be reflected back towards the viewer.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. An illuminating member for illuminating a display panel to create an image, said illuminating member, independent of any image content, comprising a central region and an enclosing region enclosing said central region, said enclosing region being adapted to emit light with a brightness which is less than 70% of the brightness of the light emitted by the central region.

2. (canceled)

3. An illuminating member according to claim 1, wherein the area of the central region has essentially the same size as the area of the enclosing region.

4. An illuminating member according to claim 1, wherein the enclosing region is adapted to emit light with a brightness which is approximately 50% of the brightness of the light emitted by the central region.

5. An illuminating member according to claim 1, wherein at least one of the central region and the enclosing region is further segmented into a lower sub-region and an upper sub-region, each emitting light of a different brightness.

6. An illuminating member according to claim 1, further comprising a controller for altering at least one attribute of the light emitted by the central region and/or the enclosing region.

7. An illuminating member according to claim 6, wherein said controller is configured to alter the at least one attribute of the light emitted by the central region and/or the enclosing region based on data associated with the image.

8. An illuminating member according to claim 1, wherein the central region and the enclosing region each comprise a plurality of light emitting elements.

9. An illuminating member according to claim 8, wherein the density of light emitting elements is lower in the enclosing region than in the central region.

10-12. (canceled)

13. A method of driving an illuminating member for illuminating a display panel to create an image, the illuminating member comprising a central region and an enclosing region enclosing said central region, said method comprising:
controlling a central region to emit light of a first brightness; and
controlling an enclosing region, enclosing said central region, to emit light with a brightness which is less than 70% of the brightness of the light emitted by the central region, said central region and said enclosing region defined independently of any image content.

14. (canceled)

15. A method according to claim 13, further comprising (i) receiving data associated with the image content and (ii) altering the brightness of the light emitted by the central region and/or the enclosing region.

16. A method according to claim 13, further comprising altering the brightness of the light emitted by the central region and/or the enclosing region based on the ambient light level.
